(19) United States
(12) Patent Application Publication
(10) Pub. No.: US 2010/0069269 A1
(43) Pub. Date: Mar. 18, 2010

(54) USE OF BETAINES AS FOAMING AGENTS AND FOAM DRAINAGE REDUCING AGENTS

(76) Inventors: Evelyne Prat, Pantin (FR); Sylvie Touzet, Anthony (FR); Florence Deschaseaux, Paris (FR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/530,176

(22) PCT Filed: Mar. 3, 2008
(86) PCT No.: PCT/EP08/52555

§ 371 Date: Nov. 24, 2009

(30) Foreign Application Priority Data
Mar. 8, 2007 (FR) 07 01695

(51) Int. Cl. B01F 17/18; C04B 38/10; C09K 8/22; C11D 1/94

(52) U.S. Cl. 507/133; 106/677; 510/237; 516/15

(57) ABSTRACT

The invention relates to the use of a betaine as a foaming agent and a foam drainage reducing agent. The invention also relates to the use of betaine in processes involving foam.

### FIELD OF THE INVENTION

The subject matter of the present invention is the use of a betaine as foaming agent and foam drainage reducing agent. Another subject matter of the present invention is the use of the betaine in processes involving the presence of foam.

### BACKGROUND

Some industrial processes or processes carried out in the private domain employ foams. In some detergent compositions, the foam is a sign, valued by the consumer, of a good cleaning power. In these compositions, the foam also makes it possible to suspend the soiling matter cleaned off and thus to separate it from the cleaned object or from the cleaned surface. Foams are also used in fire extinguishing products. Foams are also used to generate light and/or porous materials: the material cures starting from the composition forming the walls of the bubbles, which results in a structure comprising pores corresponding to the bubbles. Foams are also used to suspend and transport debris in construction operations, in the field of construction and civil engineering, in particular in operations for excavating and/or boring tunnels. The foam is also used as visual marker on ground surfaces. Foams are also used in water treatment as decontaminating agent for removing particles or soiling matter.

Numerous agents exist which are capable of generating foam. The most widely used among these are anionic surfactants, in particular alkyl ether sulfates, which exhibit a useful detergent power and generate a valued foam. A zwitterionic surfactant, cocoamidopropyldi-methyl betaine, is also known and widely used.

Numerous “foam booster” compounds have been described in order to increase the volume of foam, in particular polymers. Such polymers are used in particular in compositions for the washing of dishes by hand.

The processes described above may require a relatively lengthy lifetime of the foam, without which the operations and phenomena may not be brought to completion or experience a reduced effectiveness. For example, in the generation of a light material, the foam must remain present during the curing time. The earlier the foam drains away, the fewer pores there will be bringing about the desired lightness and/or the desired porosity. In excavation operations, the earlier the foam disappears, the less material will be evacuated.

There exists a need to generate foams having reduced drainage, that is to say foams having a water content which is kept high for a longer time and/or retaining a certain volume of foam for a longer time. A consequence of the maintenance of the high water content is, for example, a high durability in the properties, in particular mechanical properties, and/or the retention of the shape of the bubbles and/or of the homogeneity. There exists a need for agents for this purpose.

### SUMMARY OF THE INVENTION

The invention meets this need by providing for the use, in a foaming aqueous composition, as foaming agent and foam drainage reducing agent, of a betaine surfactant chosen from the following:
alkyl betaines of following formula (I):

R¹—N⁺R²—R³—CH₂—COO⁻ (I)
alkylamidoalkyl betaines of following formula (II):

R′¹—CO—NH—R₄—N⁺R²R³—CH₂—COO⁻ (II), and
their mixtures and combinations,
   where:
R¹ represents a saturated or unsaturated and linear or branched alkyl group comprising from 16 to 24 carbon atoms,
R′¹ represents a saturated or unsaturated and linear or branched alkyl group comprising from 15 to 23 carbon atoms,
R⁴ represents a divalent C₁-C₄ alkyl group, if appropriate substituted by a hydroxyl group,
R² and R³, which are identical or different, represent a C₁-C₂ alkyl group, if appropriate substituted by a hydroxyl group.

The surfactant described above is subsequently referred to as “agent of the invention” or “betaine surfactant”.

The invention also relates to a process for the preparation of foam in which an aqueous composition comprising the agent of the invention is made to foam, for example by stirring and/or by propelling with the aid of a gas.

The invention also relates to processes comprising a stage of preparation of foam and another stage, simultaneous or subsequent. The processes may be industrial processes or processes carried out in the private domain. Interest is particularly marked in the context of industrial processes.

The invention makes it possible in particular:
to retain the foam for a longer time,
to retain the foam for the same time but with reduced amounts of agent, which is economic and/or beneficial to the environment, or at least perceived as such,
to retain the homogeneity of the foam for a longer time, and/or
to have a presence of an amount of foam, cumulative over time, which is greater.

The agent of the invention provides in particular an excellent compromise between the amount of foam generated and its duration over time.

Drainage is understood to mean the flow of the water present in the foam, which can result in the degradation of the walls of the bubbles and finally in the gradual return to the state of a bubble-free aqueous composition.

### DETAILED DESCRIPTION OF PREFERRED EMBODIMENTS

### Composition and Agent of the Invention

The composition is an aqueous composition comprising the agent of the invention. The agent of the invention exhibits the property of generating foam. The foam can be generated by any conventional method, in particular by stirring, pressure reduction, employing a propellant gas, employing an aerosol device, and the like. The foam generated has a low drainage. The agent is thus both a foaming agent and a drainage reducing agent.

The composition can comprise another foaming agent which is different from the betaine surfactant. If this is the case, the ratio by weight of the betaine surfactant to the other foaming agent is preferably greater than 4, preferably greater than 5, preferably greater than 10. Preferably, the composition is devoid of another foaming agent. The term devoid is understood to mean that the composition comprises less than 0.1% by weight, preferably less than 0.05% by weight, preferably none at all, of the other foaming agent. The generation of foam and the low drainage can thus be, pursuant to the invention, the consequence of the agent of the invention substantially alone.

The foaming agents are known to a person skilled in the art. Mention is in particular made of alkyl ether sulfates, alkyl sulfates and alkylbenzenesulfonates, which are very widely used.

The foaming agent can in particular comprise from 0.05 to 5% by weight, preferably from 0.1 to 2% by weight, preferably from 0.15 to 1.5% by weight, for example from 0.2 to 1% by weight or from 0.3 to 0.7% by weight, of the betaine surfactant.

Preferably, in the agent of the invention:
R² and R³ are methyl groups, and
R⁴ is the —CH₂—CH₂—CH₂— group.

Advantageously:
R¹ represents a saturated or unsaturated and linear or branched alkyl group comprising from 18 to 22 carbon atoms, or
R′¹ represents a saturated or unsaturated and linear or branched alkyl group comprising from 17 to 21 carbon atoms.

It is mentioned that the R¹ and R′¹ groups can correspond to residues of fatty acids, generally of natural origin, most often of vegetable origin. The fatty acid to which R′¹ corresponds is the fatty acid of formula R′¹—COOH. The fatty acid to which R¹ corresponds is the fatty acid exhibiting the same number of carbon atoms. Thus, the R′¹ group can correspond to a saturated or unsaturated and linear or branched fatty acid comprising from 15 to 23, preferably from 17 to 21, carbon atoms. The R¹ group can correspond to a saturated or unsaturated and linear or branched fatty acid comprising from 16 to 24, preferably from 18 to 22, carbon atoms. It is normal to put the R¹ and R′¹ groups in the same category as the fatty acid to which they correspond.

These groups and fatty acids are known. Generally, vegetable oil derivatives are involved. They can be present as mixtures. If mixtures are concerned, all the groups (or corresponding fatty acids), whatever the number of carbon atoms, come within the definition if the predominant group (or corresponding acid) by weight (relative predominance, preferably absolute predominance, preferably to at least 75%) corresponds to the definition. Frequently, the name of the group (or of the corresponding acid) is reduced to that of the predominant group (or acid).

The R¹ and R′¹ groups can in particular correspond to C₁₈ or C₂₂ fatty acids, such as stearic, oleic or erucic acids. Preferably, they correspond to an oleyl or erucyl group.

The composition can comprise all kinds of additional ingredients, depending on its destination and its use.

The water of the composition preferably exhibits a moderate hardness, preferably a hardness ranging from 5 to 100° TH [French degree of hardness], for example from 20 to 60. Such conditions may improve the reduction in the drainage.

The pH of the composition can be varied. It can be controlled using known agents. The pH can in particular be greater than or equal to 4 or 5, preferably greater than or equal to 7, for example from 8-9 to 11-12. High pH values may improve the reduction in the drainage.

The composition and the processes in which it is employed can be of varied temperature. It is, for example, between 20° C. and 80° C., preferably between 20° C. and 40° C. or between 40° C. and 80° C. Moderate temperatures may improve the reduction in the drainage. The invention makes it possible in particular to retain a low drainage at relatively high temperatures, for example between 40° C. and 80° C., which renders it particularly useful and advantageous in certain processes carried out at relatively high temperatures.

The composition can be prepared by simple mixing of water, of the agent of the invention and optionally of other ingredients.

### Uses and Processes

The foaming composition can in particular be:
a composition comprising a hydraulic binder,
a composition for the manufacture of ceramics, which can in particular comprise a slip,
a drilling fluid,
a composition comprising compounds capable of generating a crosslinked polymeric material,
a composition for marking a ground surface,
a composition for extinguishing fires,
a composition for decontaminating water,
a foam bath composition, or
a detergent composition.

Such compositions are known to a person skilled in the art. They generally comprise supplementary compounds in addition to the agent of the invention. These are known to a person skilled in the art. Processes employing foams with such compositions are known to a person skilled in the art.

For the compositions comprising a hydraulic binder, these can in particular be cement compositions or plaster compositions for obtaining a porous and/or light and/or refractory and/or insulating material, for example a material for thermal and/or acoustic insulation. The agent of the invention can in particular be used in a process (generally of industrial type) where the composition having a hydraulic binder is made to foam and then the composition is allowed to harden in the foam form, in order to obtain the material. Another process can be to prepare a dispersion of the binder in water, to incorporate therein a foam obtained using the system of the invention and then to allow the composition to harden. Such processes can in particular be employed in order to obtain prefabricated materials, such as prefabricated structural parts.

It is the same for the compositions capable of generating an optionally crosslinked polymeric material, the hydraulic binder being replaced by a polymer, which can, if appropriate, crosslink on contact with ambient air, or by a chemical system having several compounds comprising at least one polymer or oligomer, it being possible for said system optionally to crosslink when the several compounds are brought into contact, if appropriate under the action of contact with ambient air. The compositions capable of generating a polymeric material can, for example, be latex-based compositions for addition to fibrous products, for example carpet backings and/or nonwoven surfaces. The compositions capable of generating a polymeric material can also be used in the papermaking industry.

The invention can confer good uniformity on the materials having a hydraulic binder and/or having a polymeric base.

For the compositions for the manufacture of porous ceramics (for example based on oxides), the compositions can in particular be compositions comprising a slip. The agent of the invention can in particular be used in a process where the foam is introduced into the slip (composition based on water and on ceramic precursor) so as to obtain a handleable unfired porous part which is subsequently subjected to a temperature profile in a furnace so as to obtain a porous part by sintering the oxides at high temperature.

For the drilling fluids, they can be fluids for excavating debris employed in tunnel boring operations or in well hollowing operations, before cementation of the well. The agent of the invention can in particular be used in a process (generally of industrial type) where the composition is made to foam, it is injected into a boring or hollowing device, such as a tunnel-boring machine, and the foam carrying (generally) the debris is evacuated from the region of contact of the device and of the bored or hollowed rock. The foam makes it possible in particular to prevent collapses of rock, to evacuate the debris, to fluidize the bored or hollowed rock, to homogenize it and/or to render it impermeable locally and, if appropriate, temporarily.

For the compositions for extinguishing fires, they can in particular be compositions for extinguishers or compositions employed in building safety systems. The invention provides foams having a good resistance to heat, which makes the use thereof particularly appropriate in the context of the extinguishing of fires. The fires to be extinguished can be fires occurring in buildings and/or in forests or on farms, and/or fires related to the combustion of hydrocarbons, for example during accidental or deliberate fires in plants for the extraction, storage or transportation of oil and/or gas.

For the detergent compositions, they can be compositions for cleaning dishes by hand, shampoos or shower gels for the body and hair, liquid soaps for washing the hands, compositions for washing laundry by hand or in a semiautomatic machine, detergent formulations for washing vehicles, such as cars and trucks, compositions for the household or industrial cleaning of surfaces, where it may be advantageous for the foam to have a sufficient lifetime to allow a cleaning action (for example, for the cleaning of bathrooms). In these compositions, the invention can provide, by the presence of foam, a visual sign of complete coverage of the object or of the part of the object to be cleaned. The agent of the invention can in particular be used in a process (generally carried out in the private domain) where the composition is diluted and is made to foam (by stirring, often generated by the movement of the hands or by a jet of diluting water) and the dirty dish is brought into contact with the dilute foam-exhibiting composition.

A process involving marking a ground surface comprises a stage of generating foam and a stage where the foam is left on the ground surface in order to mark it. The more the foam hardens, the more persistent the marking. The foam can be left on the ground surface by spraying it from an aircraft, for example a plane. This can be used in the military field, to identify operational areas, or in the agricultural field, to identify treatment areas.

Other details or advantages of the invention may become apparent in the light of the examples which follow, without a limiting nature.

### EXAMPLES

### Products Used

Mirataine BET C30, Rhodia (“BET C30”): cocoamido-propyldimethyl betaine
Empicol ESB3M, Huntsman (“SLES”): sodium lauryl ether sulfate—active material 27%
Mirataine BET 0-30, Rhodia (“BET 030”): oleamido-propyldimethyl betaine
Mackam OB-30, McIntyre (“OB30”): oleyldimethyl betaine
Mirataine BET E-40, Rhodia (“BET E40”): mixture comprising erucylamidopropyldimethyl betaine (40% by weight of active material) and 20% by weight of isopropanol.
Mixture 1: mixture of Mirataine BET E-40 and 10% by weight of benzyltrimethylammonium chloride,
Water: faucet water (“municipal water”) from Aubervilliers, France, December 2007.

### Equipment Used

Rayneri stirrer

3-blade propeller

21 plastic beaker with a diameter of 14.5 cm

Glass cone

### Implementation of the Drainage Test

The drainage is characterized by the half-life of the foam (by volume). The greater the half-life, the lower the drainage. The procedure is as follows:
1—Preparation of 200 ml of composition by mixing the ingredients (compositions given below), if appropriate under hot conditions (80° C.). The compositions are given below: amount of the ingredients as active material, the remainder being water.
2—Foaming
   The composition is stirred in a 2 liter beaker with a 3-blade propeller at 2000 rev/min for 5 min. The volume of foam produced is recorded.
3—The draining is monitored in a 1 liter cone until the foam has released 100 ml of water (½ life as this is half the initial composition used to prepare the foam).

The drainage improvement factor F_{drainage} is defined as the ratio of the ½ life for the test compound to the ½ life for a reference compound, SLES, at the same amount by weight. A factor of 1 provides no improvement. The higher F_{drainage}, the more the drainage is reduced. A factor of greater than 1.5 represents an advantageous improvement in the drainage of greater than 50%.

An improvement factor for the amount of foam F_{foam} is defined as the ratio of the amount of foam for the test compound to the amount of foam for a reference compound, SLES, at the same amount by weight. A factor of less than 1 corresponds to a smaller amount of foam. An improvement factor for the presence of foam F is defined as the product of F_{drainage} and F_{foam}. F is representative of a compromise between foam generated and a low drainage.

In the examples, the letter C indicates a comparative example.

### Examples 1 to 10

| | | | Foam | | |
|---|---|---|---|---|---|
| | | | produced | | |
| Example | Composition | ½ Life | (ml) | F_{drainage} | F |
| 1C | 0.24% SLES | 6 min | 1300 | 1 | 1 |
| | | (360 s) | | | |
| 2C | 0.96% SLES | 7 min 10 s | 1300 | 1 | 1 |
| | | (430 s) | | | |
| 3 | 0.24% BET | >4 h | 650 | 40 | 20 |
| | E40 | (>14 400 s) | | | |
| 4 | 0.96% BET | >17 h | 800 | >142 | >87 |
| | E40 | (>61 200 s) | | | |
| 5 | 0.24% BET | 13 min | 900 | 2.1 | 1.45 |
| | O30 | (780 s) | | | |
| 6 | 0.96% BET | 1 h 28 min | 900 | 12.3 | 8.5 |
| | O30 | (5280 s) | | | |
| 7C | 0.24% BET | 6 min 35 s | 1150 | 1.1 | 0.97 |
| | C30 | (395 s) | | | |
| 8C | 0.96% BET | 7 min 11 s | 1100 | 1 | 0.84 |
| | C30 | (431 s) | | | |
| 9 | 0.24% | 4 h 50 min | 950 | 48 | 35 |
| | Mixture 1 | (17 400 s) | | | |
| 10 | 0.96% | >17 h | 800 | >142 | >87 |
| | Mixture 1 | | | | |

Examples 1 to 10 show that
used alone, the betaine surfactants of the invention make it possible to obtain a foam having low drainage. A betaine surfactant, the alkyl of which exhibits only 12 carbon atoms (BET C-30, comparative), does not provide this effect.
the drainage/amount of foam compromise is improved.

1-11. (canceled)

12. A process of creating foam and reducing foam drainage comprising: preparing a foaming composition by adding a foaming agent comprising a betaine surfactant to an aqueous composition, wherein said betaine surfactant comprises:
alkyl betaines of following formula (I):
R¹—N⁺R²R³—CH₂—COO⁻ (I)
alkylamidoalkyl betaines of following formula (II):
R′¹—CO—NH—R⁴—N⁺R²R³—CH₂—COO⁻ (II)
and
mixtures and combinations thereof,
wherein:
R¹ represents a saturated or unsaturated and linear or branched alkyl group comprising from 16 to 24 carbon atoms,
R′¹ represents a saturated or unsaturated and linear or branched alkyl group comprising from 15 to 23 carbon atoms,
R⁴ represents a divalent C₁-C₄ alkyl group, optionally substituted by a hydroxyl group,
R² and R³, which are identical or different, represent a C₁-C₂ alkyl group, optionally substituted by a hydroxyl group.

13. The process of claim 12 wherein:
the composition optionally comprises another foaming agent that is different from the betaine surfactant,
if the composition comprises another foaming agent, then the ratio by weight of the betaine surfactant to the other foaming agent is greater than 4

14. The process of claim 13 wherein the ratio by weight of the betaine surfactant to the other foaming agent is greater than 5.

15. The process of claim 13, wherein the composition is devoid of other foaming agents.

16. The process of claim 12, wherein:
R² and R³ are methyl groups, and
R⁴ is a —CH₂—CH₂—CH₂— group.

17. The process of claim 12, wherein:
R¹ represents a saturated or unsaturated and linear or branched alkyl group comprising from 18 to 22 carbon atoms, or
R′¹ represents a saturated or unsaturated and linear or branched alkyl group comprising from 17 to 21 carbon atoms.

18. The process of claim 12, wherein:
the R¹ group or the R′¹ group comprises an oleyl or erucyl group.

19. The process of claim 12, wherein:
the foaming composition comprises betaine surfactant in an amount ranging from 0.05 to 5% by weight.

20. The process of claim 19, wherein:
the foaming composition comprises betaine surfactant in an amount ranging from 0.1 to 2% by weight.

21. The process of claim 12, wherein said foaming composition is:
a composition comprising a hydraulic binder,
a ceramic manufacturing composition,
a drilling fluid,
a composition comprising compounds capable of generating a polymeric material that is optionally crosslinked,
a ground surface marking composition,
a fire extinguishing composition,
a water decontaminating composition,
a foam bath composition, or
a detergent composition.

22. The process of claim 21, wherein the composition comprising a hydraulic binder is a cement composition or a plaster composition capable of producing a porous and/or light and/or refractory and/or insulating material.

23. The process of claim 21, wherein the drilling fluid is capable of excavating debris in a tunnel boring operation.

24. The process of claim 21, wherein the detergent composition is a handwashing dish detergent.
